(19) United States
(12) Patent Application Publication
(10) Pub. No.: US 2026/0111112 A1
(43) Pub. Date: Apr. 23, 2026

(54) CLOCK MONITORING FOR MEMORY APPARATUSES

(71) Applicant: Micron Technology, Inc., Boise, ID (US)

(72) Inventors: Pranjal Chauhan, San Jose, CA (US); Jayaprakash Naradasi, Bengaluru (IN); Tal Sharifie, Lehavim (IL); Yoav Weinberg, North York (CA); Andrew Chong, San Jose, CA (US); Melissa I. Uribe, El Dorado Hills, CA (US)

(21) Appl. No.: 19/356,611

(22) Filed: Oct. 13, 2025

Related U.S. Application Data
(60) Provisional application No. 63/708,391, filed on Oct. 17, 2024.

(51) Int. Cl. G06F 3/06

(52) U.S. Cl. CPC G06F 3/0604; G06F 3/0655; G06F 3/0679

(57) ABSTRACT

Clock monitoring for memory apparatuses is described herein. Clock signals of those components (e.g., logic blocks) of the memory apparatuses identified as being associated with causing failures of the other components can be selectively monitored. This eliminates a need to monitor all of the components, which may not be necessary when at least a portion of the components may not be fully used while the memory apparatuses are in an autonomous mode.

### PRIORITY INFORMATION

This Application claims the benefits of U.S. Provisional Application No. 63/708,391, filed on Oct. 17, 2024, the contents of which are incorporated herein by reference.

### TECHNICAL FIELD

Embodiments of the disclosure relate generally to memory systems and sub-systems, and more specifically, relate to clock monitoring for memory apparatuses.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Vehicles are becoming more dependent upon memory sub-systems to provide storage for components that were previously mechanical, independent, or non-existent. A vehicle can include a computing system, which can be a host for a memory sub-system. The computing system can run applications that provide component functionality. The vehicle may be driver operated, driver-less (autonomous), and/or partially autonomous. The memory device can be used heavily by the computing system in a vehicle.

### BRIEF DESCRIPTION OF THE DRAWINGS

The present disclosure will be understood more fully from the detailed description given below and from the accompanying drawings of various embodiments of the disclosure.

FIG. 1 illustrates an example of a computing system that includes a memory sub-system having a clock monitor component operating in accordance with some embodiments of the present disclosure.

FIG. 2 illustrates an example of a system illustrating at least a portion of a controller for monitoring clock signal failures of logic blocks in association with operating a computing system in accordance with some embodiments of the present disclosure.

FIG. 3 is a flow diagram of an example method for clock monitoring for memory apparatuses in accordance with some embodiments of the present disclosure.

FIG. 4 illustrates an example of a system including a computing system in a vehicle in accordance with some embodiments of the present disclosure.

### DETAILED DESCRIPTION

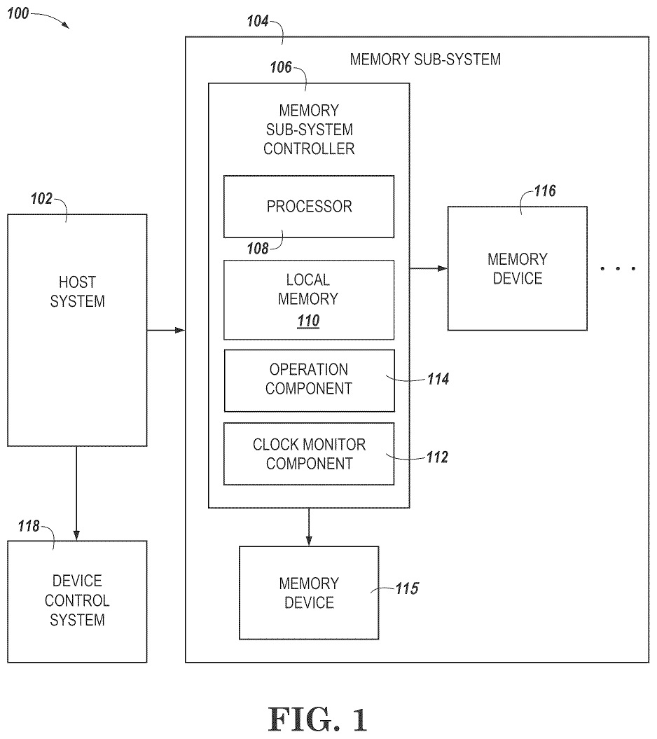

Aspects of the present disclosure are directed to clock monitoring for memory apparatuses. A memory sub-system can be a storage system, storage device, a memory module, or a combination of such. An example of a memory sub-system is a storage system such as a solid-state drive (SSD), Universal Flash Storage (UFS) drive, etc. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. As an example, a vehicle can include a memory sub-system, such as an SSD, UFS, etc. The memory sub-system can be used for data storage by various components of the vehicle, such as applications that are run by a host system of the vehicle.

Accurate and reliable clock signals are crucial in the operation of autonomous devices (e.g., autonomous vehicles, drones, vacuum cleaners, industrial robots, medical robots, etc.) because they ensure synchronization across multiple electronic control units, allowing for the coordinated functioning essential for autonomous driving tasks. Precise clock signals maintain exact timing in communication protocols, ensuring seamless data exchange between sensors, processors, and actuators. More particularly, this precision is vital for real-time decision-making processes for autonomous vehicles such as collision avoidance, lane keeping, and adaptive cruise control. Autonomous vehicles rely on accurate clock signals to process sensor and camera inputs in real-time, enabling timely responses and enhancing overall safety and reliability during autonomous operation.

To ensure the reliability of clock signals, some approaches may include a clock monitoring system designed to detect any clock failures, which could indicate hardware or systematic failures during autonomous operations of these devices. While these monitoring systems are typically used continuously to maintain reliability, they can lead to significant power consumption. Additionally, such systems, which need to monitor numerous hardware blocks continuously, may be complex and relatively large in size, potentially increasing the overall design complexity of computing systems for autonomous devices.

Aspects of the present disclosure address the above and other issues by selectively monitoring clock signals, for example, depending on whether the clock signals are “essential” signals for operating devices autonomously. For example, the clock monitoring system, in accordance with embodiments of the present disclosure, can continuously monitor clock signals (among those “essential” signals) whose failures can likely lead to failures of other components of the autonomous device. Non-essential clock signals, however, are monitored periodically as needed. This reduces the power consumption and area required for the clock monitoring system, such as by 5 percent as compared to the clock monitoring system that runs continuously for every clock signals. Further, the clock monitoring system in this disclosure is designed to be relatively compact and less complex, thereby simplifying the overall design complexity of computing systems for autonomous devices.

In various embodiments, the clock monitoring system is implemented as a hardware component, such as dedicated circuitry, eliminating the reliance on firmware-based (e.g., periodic) clock monitoring. This design improves system efficiency by enhancing the response time to the host. Additionally, because the clock monitoring operates independently of the other components, such as central processing unit (CPU) and static random-access memory (SRAM), it remains unaffected by faults in these components, thereby ensuring continuous operation and significantly increasing the system's reliability and robustness.

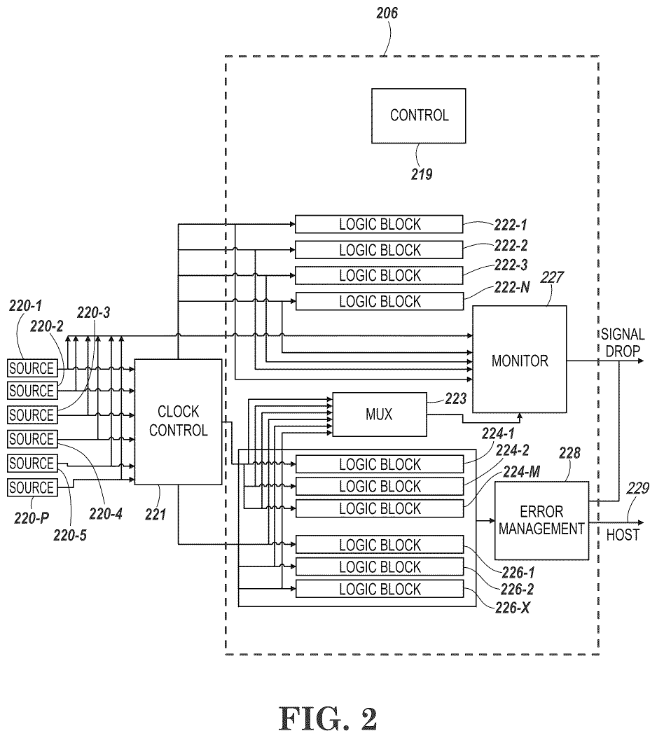

The figures herein follow a numbering convention in which the first digit or digits correspond to the drawing figure number and the remaining digits identify an element or component in the drawing. Similar elements or components between different figures may be identified by the use of similar digits. For example, 112 may reference element “12” in FIG. 1, and a similar element may be referenced as 212 in FIG. 2. Analogous elements within a Figure may be referenced with a hyphen and extra numeral or letter. Such analogous elements may be generally referenced without the hyphen and extra numeral or letter. For example, elements 222-1, 222-2, . . . , 222-N in FIG. 2 may be collectively referenced as 222. As used herein, the designator “N”, “M”, “P”, “X”, or “Q” particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example computing system 100 that includes a memory sub-system 104 (alternatively referred to as memory device 104) operating in accordance with some embodiments of the present disclosure. The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 includes a host system 102 that is coupled to one or more memory sub-systems 104. The host system 102 can be a computing system included in a vehicle, and the computing system can run applications that provide component functionality for the vehicle, for example. In some embodiments, the host system 102 is coupled to different types of memory sub-systems 104. FIG. 1 illustrates an example of a host system 102 coupled to one memory sub-system 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 includes or is coupled to processing resources, memory resources, and network resources. As used herein, “resources” are physical or virtual components that have a finite availability within a computing system 100. For example, the processing resources include a processing device, the memory resources include memory sub-system 104 for secondary storage and main memory devices (not specifically illustrated) for primary storage, and the network resources include a network interface (not specifically illustrated). The processing device can be one or more processor chipsets, which can execute a software stack. The processing device can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

The host system 102 can run one or more applications. For instance, the applications can run on an operating system (not specifically illustrated) executed by the host system 102. An operating system is system software that manages computer hardware, software resources, and provides common services for the applications. An application is a collection of instructions that can be executed to perform a specific task. By way of example, the application can be a black box application for a vehicle, however embodiments are not so limited.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open not-and (NAND) Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access the non-volatile memory devices 116 when the memory sub-system 104 is coupled with the host system 102 by the PCIe interface. The physical host interface can provide an interface for passing control, address, data, and other signals between the memory sub-system 104 and the host system 102. FIG. 1 illustrates a memory sub-system 104 as an example. In general, the host system 102 can access multiple memory sub-systems via the same communication connection, multiple separate communication connections, and/or a combination of communication connections.

As illustrated in FIG. 1, the host 102 and the memory sub-system 104 are further coupled to the device control 118. The device control 118 can manage physical control of one or more devices, such as autonomous devices (based on requests, commands, etc. received from the host 102 or input data received from the memory sub-system 104), for example, when the devices are operated autonomously or partially autonomously. In an example, in which the computing system 100 corresponds to an autonomous vehicle, the physical control of the vehicles that can be managed by the device control 118 can include switching the ignition or the start control that controls the start of the vehicle; turning the steering wheel or the steering or steering device that controls the steer of the vehicle; course or direction of the vehicle; increasing or decreasing the throttle or acceleration or the throttle control that controls the speed of the vehicle, thus changing the speed of the vehicle; applying or releasing the brakes; switching on/off direction indicators; controlling lights on the vehicle (e.g., by turning on/off the headlamps, parking brakes, fog lights etc.); activating warning signals (e.g., sounding a horn; hazard lights); locking or unlocking the doors; activating the windscreen wipers; parking sensors or controls; and/or changing the gear of the vehicle, among others.

The host system 102 can control and/or send requests (e.g., commands) to the memory sub-system 104, for example, to store data in the memory sub-system 104 or to read data from the memory sub-system 104. For example, the host system 102 can use the memory sub-system 104 to provide storage for a black box application. The data to be written or read, as specified by a host request, is referred to as “host data.” A host request can include logical address information. The logical address information can be a logical block address (LBA), which may include or be accompanied by a partition number. The logical address information is the location the host system associates with the host data. The logical address information can be part of metadata for the host data. The LBA may also correspond (e.g., dynamically map) to a physical address, such as a physical block address (PBA), that indicates the physical location where the host data is stored in memory.

The memory sub-system 104 can include media, such as one or more volatile memory devices 115, one or more non-volatile memory devices 116, or a combination thereof. The volatile memory devices 115 can be, but are not limited to, random access memory (RAM), such as dynamic random access memory (DRAM), synchronous dynamic random access memory (SDRAM), and resistive DRAM (RDRAM).

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

An example of non-volatile memory devices 116 include NAND type flash memory. NAND type flash memory includes, for example, two-dimensional NAND (2D NAND) and three-dimensional NAND (3D NAND). The non-volatile memory devices 116 can be other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and three-dimensional cross-point memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the non-volatile memory devices 116 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the non-volatile memory devices 116 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the non-volatile memory devices 116 can be grouped as pages that can refer to a logical unit of the memory device used to store data. With some types of memory (e.g., NAND), pages can be grouped to form blocks.

The memory sub-system controller 106 (or controller 106 for simplicity) can communicate with the non-volatile memory devices 116 to perform operations such as reading data, writing data, erasing data, and other such operations at the non-volatile memory devices 116. The memory sub-system controller 106 can include hardware such as one or more integrated circuits and/or discrete components, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

The memory sub-system controller 106 can include a processing device 108 (e.g., a processor, which can be a central processing unit (CPU)) that can include processing resources and configured to execute instructions stored in local memory 110. Local memory 110 can be, for instance, static random access memory (SRAM). In the illustrated example, the local memory 110 of the memory sub-system controller 106 is an embedded memory configured to store instructions for performing various processes, operations, logic flows, and routines that control operation of the memory sub-system 104, including handling communications between the memory sub-system 104 and the host system 102. For example, local memory 110 can store instructions that can be executed by the processor 108 and/or the operation component 114, as will be further described herein.

In some embodiments, the local memory 110 can include memory registers storing memory pointers, fetched data, etc. The local memory 110 can also include ROM for storing micro-code, for example. While the example memory sub-system 104 in FIG. 1 has been illustrated as including the memory sub-system controller 106, in another embodiment of the present disclosure, a memory sub-system 104 does not include a memory sub-system controller 106, and can instead rely upon external control (e.g., provided by an external host, or by a processor or controller separate from the memory sub-system 104). In some embodiments, the memory sub-system 104 can be a managed NAND (MNAND) device in which an external controller (e.g., controller 106) is packaged together with one or more NAND die (e.g., the non-volatile memory device 116).

In general, the memory sub-system controller 106 can receive information or operations from the host system 102 and can convert the information or operations into instructions or appropriate information to achieve the desired access to the non-volatile memory devices 116 and/or the volatile memory devices 115. The memory sub-system controller 106 can be responsible for other operations such as wear leveling operations, error detection and/or correction operations, encryption operations, caching operations, and address translations between a logical address (e.g., logical block address) and a physical address (e.g., physical block address) associated with the non-volatile memory devices 116. The memory sub-system controller 106 can further include host interface circuitry to communicate with the host system 102 via the physical host interface. The host interface circuitry can convert a query received from the host system 102 into a command to access the non-volatile memory devices 116 and/or the volatile memory devices 115 as well as convert responses associated with the non-volatile memory devices 116 and/or the volatile memory devices 115 into information for the host system 102.

As shown in FIG. 1, the memory sub-system 104 can include clock monitor component 112 and an operation component 114. Although not shown in FIG. 1 so as to not obfuscate the drawings, the clock monitor component 112 can include various circuitry to facilitate aspects of the disclosure described herein. In some embodiments, the clock monitor component 112 and/or the operation component 114 can include firmware, special purpose circuitry in the form of an ASIC, FPGA, state machine, hardware processing device, and/or other logic circuitry that can allow the clock monitor component 112 and/or the operation component 114 to orchestrate and/or perform operations described herein.

The operation component 114, which can be firmware or hardware, or any combination thereof, can manage and/or control operations of the computing system 100 (e.g., such as an autonomous device). In some embodiments, at least a portion of the operation component 114 can be part of (e.g., integrated part of) the processor 108 (e.g., CPU). The operation component 114 can include various logic blocks (e.g., logic blocks 222-1, . . . , 222-N, 224-1, . . . 224-M, 226-1, . . . 226-X illustrated in FIG. 2) ensures the operations of the computing system 100 meet safety standards, for example, as defined by the Safety Standard ISO 26262, the requirements for autonomously or non-autonomously operating the computing system 100, or any combination thereof.

The clock monitor component 112 can monitor clock signals provided to (e.g., being provided to) the operation component 114 to detect any clock signal failures (simply referred to as “clock failures” and alternatively referred to as “erroneous clock signals”). The monitoring of the clock signals can be selectively performed depending on whether they play a critical role in the autonomous operation of the computing system 100 and/or whether they are identified as potentially causing failures of other components (e.g., logic blocks 222, 224, 226 illustrated in FIG. 2) once the clock signals themselves become erroneous. Further details of the monitoring of the logic blocks 222, 224, 226 are described in association with FIG. 2.

FIG. 2 illustrates an example of a system 200 (e.g., analogous to the computing system 100) illustrating at least a portion of a controller 206 (e.g., analogous to the controller 106) for monitoring clock signal failures of logic blocks in association with operating a computing system in accordance with some embodiments of the present disclosure. More particularly, a portion of the controller 206 illustrated in FIG. 2 can be part of the clock monitor component 112 illustrated in FIG. 1.

The system 200 can include one or more clock sources, such as clock sources 220-1, . . . , 220-P (collectively referred to as clock sources 220 and shown as “source” in FIG. 2), which can be oscillator (e.g., crystal oscillator, RC oscillator, LC oscillator, ring oscillator, etc.), phase locked loop (PLL), etc., or any combination thereof. Clock signals respectively generated at the clock sources 220 can be (e.g., selectively) provided to a clock control component 221 as well as to monitor circuitry 227. Further, clock signals generated at the clock control component 221 can be further (e.g., selectively) provided to the monitor circuitry 227. In some embodiments, the clock control component 221 can include firmware, special purpose circuitry in the form of an ASIC, FPGA, state machine, hardware processing device, and/or other logic circuitry that can allow the clock control component 221 to orchestrate and/or perform operations described herein. More particularly, the clock control component 221 can be a clock control logic for managing system blocks (of the system 200 that may be located internal and/or external to the controller 206), enabling or disabling clock signals as need, and performing clock division.

In some embodiments, the clock control component 221 can be (at least partially) a clock divider. As used herein, the term “clock divider” refers to an electronic circuit or device that takes an input clock signal and produces an output clock signal possibly with a different (e.g., lower) frequency. For example, the clock signals respectively generated at the clock sources 220 can be received at the control component 221 as respective input clock signals that can be further utilized for generating output clock signals at the control component 221. Although it is illustrated in FIG. 2 that the clock sources 220 and the control component 221 are located external to the controller 206, embodiments are not so limited. For example, the clock sources 220 and the control component 221 can be resident on and/or part of the memory sub-system controller 206.

The output clock signals generated at the control component 221 are further propagated and provided to various different components, logic blocks, etc. of the memory sub-system (e.g., the memory-sub system 104 illustrated in FIG. 1), which can include a processor 208 (analogous to the processor 108 illustrated in FIG. 1), first logic blocks 222-1, . . . , 222-N (collectively referred to as logic blocks 222), second logic blocks 224-1, . . . , 224-M (collectively referred to as logic blocks 224), and third logic blocks 226-1, . . . , 226-X (collectively referred to as logic blocks 226). As used herein, the term “logic block” refers to a unit of a hardware (e.g., physical) component (often accompanied with respective firmware) that performs specific functions that may be essential to the system's overall operation (e.g., the operation of the system 200).

The logic blocks 222 (alternatively referred to as “mission mode logic”) can be those logic blocks configured for and/or responsible for the active execution of tasks that are required to operate the system 200 (e.g., the computing system 100 illustrated in FIG. 1) autonomously (e.g., in an autonomous mode) and/or meet the safety requirements (as defined by ISO 26262) while the system 200 is being operated in the autonomous mode. As used herein, the term “autonomous mode” (alternatively referred to as “mission mode”) refers to the operational state where the autonomous device is actively carrying out its predefined tasks or missions with reduced human intervention. For example, the autonomous device may perform various particular operations dedicated to the autonomous mode, such as the autonomous navigation, decision-making, operations tailored to safety and efficiency, and execution of actions needed to complete specific objectives set by the user or system, although embodiments are not so limited. Further, as used herein, the term “non-autonomous mode” (alternatively referred to as “non-mission mode”) refers to the operational state where the autonomous device is not actively carrying out its predefined tasks or missions, which may require increased human intervention in operating the system. Although embodiments are not so limited, the logic blocks 222 can also include a processing resource, such as firmware, CPU, or any combination thereof (e.g., processor/processing resource 108 illustrated in FIG. 1).

The logic blocks 224 can be those logic blocks configured for and/or responsible for the active execution of tasks that are required to operate the system 200 non-autonomously (e.g., in a non-autonomous mode). This can include ensuring that the non-autonomously operating the system 200 meets the safety requirements as defined by ISO 26262. For example, although embodiments are not so limited, the logic blocks 224 can include safety microcontrollers (e.g., configured for error detection, correction, etc. to ensure the reliability of operating the autonomous device), logic blocks to control brake-by-wire or steer-by-wire systems, safe power supply units (e.g., ensuring uninterrupted power to various components of the autonomous device), functional safety monitors (e.g., monitoring the performance and health of critical systems, detecting faults, and initiating safe), logic blocks to control health monitoring systems (e.g., monitoring performance of the autonomous device, ensuring that operation is within safe parameters and initiating corrective actions when deviations are detected), logic blocks to control emergency stop systems (e.g., emergency braking systems), logic blocks to control fail-safe actuators (e.g., brake actuators), and/or logic blocks to control driver assistance systems, such as advanced driving assistance systems (ADAS), among others.

The logic blocks 226 can be those logic blocks configured for and/or responsible for the active execution of tasks that are required to operate the system 200 autonomously and/or non-autonomously (regardless of whether the system 200 is in an autonomous mode or a non-autonomous mode). For example, although embodiments are not so limited, the logic blocks 226 can include logic blocks to control battery management system (BMS), communication modules configured to wirelessly communicate, such as via cellular, Wi-Fi, and V2X, power distribution units (PDUs), inertial measurement units (IMUs), logic blocks to control or communicate with sensors (e.g., LIDAR, cameras, radar, ultrasonic sensors, etc.), logic blocks to control user interface (UI), display screens, etc., and/or logic blocks to control cooling system, among others.

In a number of embodiments, the logic blocks 222 may be primarily “enabled” during the autonomous mode of the system 200, while the logic blocks 224 may be primarily “enabled” during the non-autonomous mode of the system 200. Alternatively, the logic blocks 222 may be primarily “disabled” during the non-autonomous mode of the system 200, while the logic blocks 224 may be primarily “disabled” during the autonomous mode of the system 200. In some embodiments, one or more the logic blocks 226 may remain “enabled” regardless of whether the system 200 is in an autonomous mode or a non-autonomous mode.

Embodiments are not limited to a particular mode. In which logic blocks 222, 224, 226 may be primarily “enabled” or “disabled”. Accordingly, embodiments of the present disclosure provide selective routing of clock signals of the logic blocks 222, 224, 226 to monitor circuitry 227 regardless of (independently of) whether the system 200 is in an autonomous mode or a non-autonomous mode. Rather, the routing can be performed solely based on the indication (e.g., identification) from the failure analysis described herein.

A failure analysis (alternatively referred to as “failure analysis operation) can be performed on clock signals provided (e.g., being provided) to logic blocks, such as logic blocks 222. For example, the failure analysis can be performed external to the computing system 200 and the result of the failure analysis can be used in association with the operation of the system 200.

Although embodiments are not so limited, the failure analysis can be a dependent failure analysis (DFA). As used herein, the term “dependent failure analysis” or “DFA” refers to a failure analysis to assess the impact of failures that are dependent (e.g., not independent). As used herein, the term “dependent failure” refers to a failure of two or more components (e.g., logic blocks 222, 224, 226) due to a shared cause or interdependencies among them. In one example, multiple components can fail due to a single shared cause (which can be referred to as common cause failures (CCF)). In another example, the failure of one component (e.g., clock sources 220, logic blocks 222, 224, 226, etc.) can lead to the failure of another component (which can be referred to as cascading failure). For example, a failure of one clock source 220 (alternatively referred to as “shared resource”) from which a clock signal is being provided (e.g., shared) to multiple logic blocks (e.g., logic blocks 222) can eventually cause failures (e.g., dependent failures) of those logic blocks. Further, a failure of one clock source can often lead to a failure or malfunction of error notification logic (e.g., CPU 208), which can further interrupt error management capabilities of the computing system 100 (e.g., by interrupting the ability of host 102 to fun to function as a decision-making entity). Therefore, the DFA performed can identify those clock sources (e.g., clock sources 220) and/or blocks (e.g., logic blocks 222, 224, 226) that are involved with dependent failures, which can be critical for autonomous operations of the computing system 100 (e.g., autonomous devices, such as autonomous devices).

The control logic 219 can be communicatively coupled to the monitor circuitry 227 and multiplexor 223 (shown as “MUX” in FIG. 2) and coordinate signal routings at least based on the result of the failure analysis performed on the clock signals of and/or the logic blocks 222, 224, 226. For example, the control logic 219 can receive information associated with those logic blocks (e.g., logic blocks 222) identified by the failure analysis (e.g., as being associated with causing dependent failures of the other logic blocks 222). Further, the control logic 219 can selectively route clock signals (being provided to one or more logic blocks 222, 224, and 226) to the monitor circuitry 227 to cause the monitor circuitry 227 to selectively monitor the routed clock signals. As used herein, clock signals provided to logic blocks (e.g., logic blocks 222, 224, 226) can be alternatively referred to as “clock signals of logic blocks”.

In an example, while the computing system 100 is being operated autonomously or in an autonomous mode, the control logic 219 can route clock signals being provided (e.g., of) to those logic blocks 222 identified by the failure analysis, such as DFA (e.g., as potentially resulting in dependent) to the monitor circuitry 227. On the other hand, clock signals of those clock sources 220 and/or logic blocks 222 that were not identified by the failure analysis may not necessarily be routed to the monitor circuitry 227 (such that they are not monitored). In some embodiments, the monitor circuitry 227 can monitor clock signals used by one or more logic blocks 222 in a continuous manner or continuously (e.g., as opposed to monitoring in a periodic manner or periodically).

In an example, the control logic 219 can route clock signals being provided (e.g., of) to one or more logic blocks 224, 226 to the monitor circuitry 227. For example, a multiplexor coupled between the monitor circuitry 227 and the logic blocks 224, 226 can selectively provide selected clock signals of logic blocks 224, 226 to the monitor circuitry 227 to allow the monitor circuitry 227 to monitor the clock signals. In some embodiments, the selected clocks signals of the logic blocks 224, 226 can be monitored in a periodic manner or periodically (e.g., as opposed to monitoring in a continuous manner or continuously).

As used herein, the term “continuously” or “in a continuous manner” means happening without interruption. For example, if the operation (e.g., monitoring) is performed “continuously” or “in a continuous manner”, it means that the operation is running without substantial and/or intentionally breaks or pauses. As used herein, the term “periodically” or “in a periodic manner” means happening at regular intervals. For example, if the operation (e.g., monitoring) is performed “periodically” or “in a periodic manner”, it means the separate happenings of the operation with a consistent time gap (e.g., intentionally introduced) between respective happenings.

The monitor circuitry 227 can identify clock failures (alternatively referred to as clock errors) on those clock signals being monitored by the monitor circuitry 227. In one example, the monitor circuitry 227 can identify a clock failure by comparing respective clock signals received from the clock sources 220 and/or the clock control component 221 to the expected frequency or phase. The clock failure is identified when the selected clock signals of the logic blocks show deviation from the expected frequency or phase determined (e.g., calculated) based on the clock signal received from the clock source.

Once the clock failure (e.g., which can negatively affect the mission mode logic and safety mechanisms of the system 200) is identified, the monitor circuitry 227 can trigger a signal drop (alternatively referred to as “link drop”) by outputting a trigger signal, for example. As used herein, the term “signal drop” refers to a loss (e.g., intentional loss) of communication between two entities, such as between the host 102 and the memory sub-system 104. For example, the “signal drop” can be achieved by resetting the memory sub-system 104 or putting the memory sub-system 104 into a reduced power state (e.g., inactive, power sleep, or power-off state), among others. The signal drop triggered by the monitor circuitry 227 can avoid the situation, in which the host 102 engages in decision-making processes based on faulty or incorrect data that would have been provided from the memory sub-system 104. This helps avoid safety risks, especially when the host 102 relies on real-time data obtained from the memory sub-system 104 for its decision-making processes. By ensuring that only accurate data is used, particularly within short time frames, overall safety and reliability of the computing system 100 can be enhanced.

The logic blocks 224 and 226 can be coupled to error management circuitry 228. The error management circuitry 228 can provide various safety mechanisms for the logic blocks 224, 226, such as correcting and/or detecting errors on data received from the logic blocks 224 and/or 226, although embodiments are not so limited. The error management circuitry 228 can include special purpose circuitry in the form of an ASIC, FPGA, state machine, hardware processing device, and/or other logic circuitry that can allow the error management circuitry 228 to orchestrate and/or perform operations, such as error correction and/or detection operations using parity bits, cyclic redundancy check (CRC) bits. The error management circuitry 228 can further utilize “timeout” mechanism, which can alert the host 102 of errors when error correction and/or detection process (e.g., single error correction and double error detection (SECDED)) exceeds (e.g., takes longer than) a predefined time period. Although embodiments are not so limited, the error management circuitry 228 can further be a temperature sensor, voltage monitor (e.g., to monitor output voltages of regulators of the computing system 200).

The error management circuitry 228 can also trigger a signal drop. For example, the error management circuitry 228 can be configured to trigger a signal drop for some types of errors that may be critical to the computing system 200 operating autonomously. Additionally or alternatively, the error management circuitry 228 can report errors to the host 102 via a sideband channel (e.g., communication channel 229), which can include data and one or more pins, such as General-Purpose Input/Output (GPIO) pins. In some embodiments, the communication channel can be a secondary communication channel (e.g., a sideband channel) in addition to a primary communication channel. The communication channel as a sideband channel can operate in parallel with the primary communication channel, which improves response time to the host 102 and/or the vehicle control system (e.g., the vehicle control system 118 illustrated in FIG. 1).

The communication channel 229 can serve as a means to communicate further details/information of errors to the host 102, such as the source of the error (e.g., from a temperature sensor), the type of error detected, the severity of the error, the timestamp when the error occurred, etc. For example, the host 102 may detect the signal drop subsequent to detecting a lack of communication from the controller 106 for a particular period of time. In this event, the host 102 (e.g., automotive system applications) that has been monitoring the controller 106 can request or poll the details of errors from the controller 106 and the details can be provided back to the host 102 via the sideband channel 229.

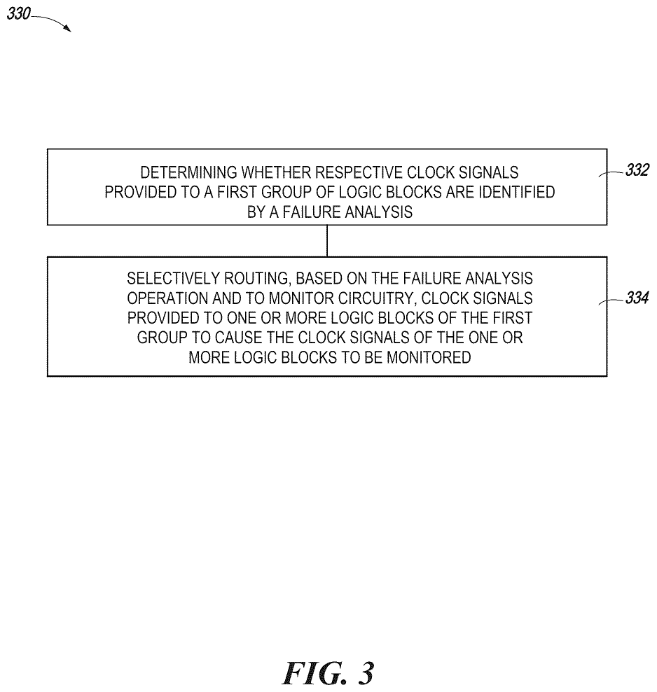

FIG. 3 is a flow diagram of an example method 330 for managing errors associated with operating a computing system (e.g., the computing system 100 illustrated in FIG. 1) in accordance with some embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the memory sub-system controller 106, 206, 406 (e.g., the clock monitor component 112 shown in FIG. 1) shown in FIGS. 1-2 and 4, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 332, it can be determined whether respective clock signals provided to a first group of logic blocks (e.g., logic blocks 222 illustrated in FIG. 2) are identified (e.g., identified or indicated as being associated with causing a dependent failure of the other logic blocks of the first group) by a failure analysis. At 334, clock signals provided to one or more logic blocks 222 of the first group can be selectively routed to monitor circuitry (e.g., the monitor circuitry 227 illustrated in FIG. 2) to cause the clock signals of the one or more logic blocks 222 to be monitored. The clock signals to be routed to the monitor circuitry 227 can be selected based on the failure analysis operation. The selected clock signals provided to the one or more logic blocks can be monitored (by the monitor circuitry 227) continuously. Further, a signal drop can be triggered responsive to determining that the clock signals of the one or more logic blocks 222 are erroneous.

In some embodiments, during an autonomous mode, the first group of logic blocks 222 that are configured to operate during the autonomous mode can be enabled, while one or more logic blocks of a second group of logic blocks (e.g., logic blocks 224, 226 illustrated in FIG. 2) can be selectively enabled. In some embodiments, during a non-autonomous mode, disabling the first group of logic blocks 222 can be disabled, while the second group of logic blocks 224, 226 that are configured to operate during the non-autonomous mode can be enabled.

In this example, during the autonomous mode, clock signals provided to one or more logic blocks of the second group of logic blocks 224, 226 can be selectively routed to the monitor circuitry 227 to cause the clock signals of the one or more logic blocks 224, 226 of the second group to be monitored by the monitor circuitry 227. The clock signals provided to the logic blocks 224, 226 of the second group can be monitored (by the monitor circuitry 227) periodically.

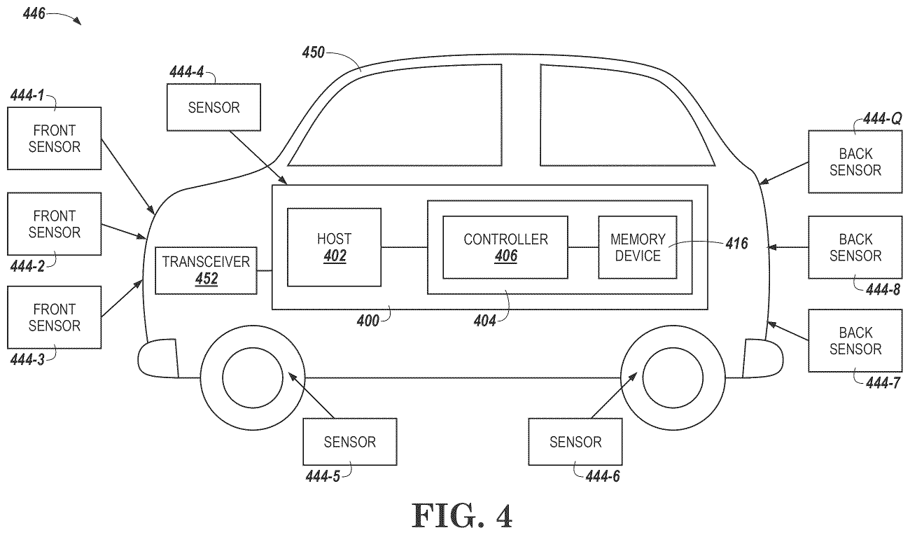

FIG. 4 illustrates an example of a system 446 including a computing system 400 in a vehicle in accordance with some embodiments of the present disclosure. The computing system 400 can include a memory sub-system 404, which is illustrated as including a controller 406 and non-volatile memory device 416 for simplicity but is analogous to the memory sub-system 104 illustrated in FIG. 1. The computing system 400, and thus the host 402, can be coupled to a number of sensors 444 either directly, as illustrated for the sensor 444-4 or via a transceiver 452 as illustrated for the sensors 444-1, 444-2, 444-3, 444-5, 444-6, 444-7, 444-8, . . . , 444-Q (collectively referred to as sensors 444). The transceiver 452 is able to receive data from the sensors 444 wirelessly, such as by radio frequency communication. In at least one embodiment, each of the sensors 444 can communicate with the computing system 400 wirelessly via the transceiver 452. In at least one embodiment, each of the sensors 444 is connected directly to the computing system 400 (e.g., via wires or optical cables).

The vehicle 450 can be a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, a ship, and/or anything used for transporting people and/or goods. The sensors 444 are illustrated in FIG. 4 as including example attributes. For example, sensors 444-1, 444-2, and 444-3 are cameras collecting data from the front of the vehicle 450. Sensors 444-4, 444-5, and 444-6 are microphone sensors collecting data from the front, middle, and back of the vehicle 450. The sensors 444-7, 444-8, and 444-Q are cameras collecting data from the back of the vehicle 450. As another example, the sensors 444-5, 444-6 are tire pressure sensors. As another example, the sensor 444-4 is a navigation sensor, such as a global positioning system (GPS) receiver. As another example, the sensor 444-6 is a speedometer. As another example, the sensor 444-4 represents a number of engine sensors such as a temperature sensor, a pressure sensor, a voltmeter, an ammeter, a tachometer, a fuel gauge, etc. As another example, the sensor 444-4 represents a camera. Video data can be received from any of the sensors 444 associated with the vehicle 450 comprising cameras. In at least one embodiment, the video data can be compressed by the host 402 before providing the video data to the memory sub-system 404.

The host 402 can execute instructions to provide an overall control system and/or operating system for the vehicle 450. The host 402 can be a controller designed to assist in automation endeavors of the vehicle 450. For example, the host 402 can be an advanced driver assistance system controller (ADAS). An ADAS can monitor data to prevent accidents and provide warning of potentially unsafe situations. For example, the ADAS can monitor sensors in the vehicle 450 and take control of vehicle 450 operations to avoid accident or injury (e.g., to avoid accidents in the case of an incapacitated user of a vehicle). The host 402 may need to act and make decisions quickly to avoid accidents. The memory sub-system 504 can store reference data in the non-volatile memory device 116 such that data from the sensors 444 can be compared to the reference data by the host 402 in order to make quick decisions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a machine-readable storage medium, such as, but not limited to, types of disks, semiconductor-based memory, magnetic or optical cards, or other types of media suitable for storing electronic instructions.

The present disclosure can be provided as a computer program product, or software, that can include a machine-readable medium having stored thereon instructions, which can be used to program a computer system (or other electronic devices) to perform a process according to the present disclosure. A machine-readable medium includes a mechanism for storing information in a form readable by a machine (e.g., a computer).

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
determining whether respective clock signals provided to a first group of logic blocks are identified by a failure analysis; and
selectively routing, responsive to determining that clock signals provided to one or more logic blocks of a first group of logic blocks are identified by the failure analysis, the identified clock signals to monitor circuitry to cause the clock signals to be monitored.

2. The method of claim 1, further comprising triggering a signal drop responsive to determining that the clock signals of the one or more logic blocks are erroneous.

3. The method of claim 1, wherein:
during an autonomous mode:
enabling the first group of logic blocks that are configured to operate during the autonomous mode; and
selectively enabling one or more logic blocks of a second group of logic blocks.

4. The method of claim 3, further comprising, during the autonomous mode:
selectively routing, to the monitor circuitry, clock signals provided to one or more logic blocks of the second group of logic blocks to cause the clock signals of the one or more logic blocks of the second group to be monitored by the monitor circuitry.

5. The method of claim 3, further comprising, during a non-autonomous mode:
disabling the first group of logic blocks; and
enabling the second group of logic blocks that are configured to operate during the non-autonomous mode.

6. The method of claim 3, further comprising, during the autonomous mode:
monitoring the clock signals provided to the logic blocks of the second group periodically.

7. The method of claim 1, further comprising monitoring the selected clock signals provided to the one or more logic blocks continuously.

8. An apparatus, comprising:
a first group of logic blocks configured to operate during a first operational state of the apparatus; and
a controller configured to selectively route respective clock signals of one or more logic blocks of the first group to monitor circuitry to cause the monitor circuitry to monitor the respective clock signals, wherein the respective clock signals are identified as being associated with causing a dependent failure of logic blocks of the first group of logic blocks.

9. The apparatus of claim 8, wherein the respective clock signals are identified by a dependent failure analysis (DFA).

10. The apparatus of claim 8, wherein the monitor circuitry is configured to output a trigger signal to trigger a signal drop of the apparatus in response to at least one clock signal of the respective clock signals being determined to be erroneous.

11. The apparatus of claim 8, wherein the clock signals of the first group of logic blocks comprises clock signals provided to the first group of logic blocks from one or more clock sources, a clock divider, or any combination thereof.

12. The apparatus of claim 8, further comprising:
a second group of logic blocks configured to operate during a second operational state of the apparatus; and
a multiplexor coupled between the monitor circuitry and the second group of logic blocks;
wherein the controller is configured to control the multiplexor to selectively route at least one of clock signals of the second group of logic blocks to the monitor circuitry.

13. The apparatus of claim 12, wherein the controller is configured to selectively route the at least one of clock signals of the second group of logic block to the monitor circuitry to cause the at least one of clock signals of the second group to be monitored periodically.

14. An apparatus, comprising:
a first group of logic blocks configured to operate, during an autonomous mode of the apparatus, based on first clock signals; and
a controller configured to monitor selected clock signals that are provided to one or more logic blocks of the first group and identified as being associated with causing a dependent failure of logic blocks of the first group of logic blocks.

15. The apparatus of claim 14, wherein the controller is further configured to trigger a signal drop in response to a detection of a clock failure on the selected clock signals.

16. The apparatus of claim 14, further comprising:
a second group of logic blocks configured to operate during a non-autonomous mode of the apparatus; and
wherein the controller is configured to monitor a selected clock signal of a logic block of the second group.

17. The apparatus of claim 16, wherein the controller is further configured to trigger a signal drop in response to a detection of one or more errors in data provided from the second group of logic blocks.

18. The apparatus of claim 17, wherein the controller is further configured to provide, to a host, information associated with the one or more errors associated with the second group of logic blocks.

19. The apparatus of claim 16, wherein the controller is further configured to monitor the selected clock signal of the logic block of the second group periodically.

20. The apparatus of claim 14, wherein the apparatus is an autonomous vehicle.
